(19) United States
(12) Patent Application Publication
(10) Pub. No.: US 2009/0044111 A1
(43) Pub. Date: Feb. 12, 2009

(54) IMAGE FORMING APPARATUS AND METHOD TO OFFER HELP INFORMATION THEREIN

(75) Inventor: Dae-gon EUN, Hwaseong-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/176,541

(22) Filed: Jul. 21, 2008

(30) Foreign Application Priority Data
Aug. 7, 2007 (KR) 2007-79145

(51) Int. Cl. G06F 3/048

(52) U.S. Cl. 715/705

(57) ABSTRACT

An image forming apparatus and a method to offer help information therein include an input unit to receive a search request command to search help information from a user, a storage to store at least one help moving picture, a display to display the help moving picture, and a controller to control the display to display a help moving picture corresponding to the search request command.

### CROSS-REFERENCE TO RELATED APPLICATIONS

This application claims priority under 35 U.S.C. §119(a) from Korean Patent Application No. 10-2007-0079145, filed on Aug. 7, 2007 in the Korean Intellectual Property Office, the disclosure of which is incorporated herein in its entirety by reference.

### BACKGROUND OF THE INVENTION

1. Field of the Invention

Apparatuses and methods consistent with the present general inventive concept relate to an image forming apparatus to provide help information for a user to solve a problem or instruct a using method of the image forming apparatus, and a method to offer the help information therein.

2. Description of the Related Art

An image forming apparatus, for instance, a printer, a multi function device and a scanner provides a user with a manual such as a help manual to solve a problem or instruct a using method of the image forming apparatus.

The help information is provided as a book or an electronic manual.

Herein, when the help information is provided as the book, searching for desired information by a user is not easy and can be of little use to solve the problem or learn the using method because the help information is usually provided as text or a drawing.

Also, because the electronic manual is provided to the user through an application program such as a driver, a host apparatus such as a computer in which the application program is installed is necessary so that the user is capable of searching the help information.

Moreover, because the help information is provided as the book or the electronic manual by a manufacturing company of the image forming apparatus, there is a limit to provide suitable information for the user.

### SUMMARY OF THE INVENTION

The present general inventive concept provides an image forming apparatus to provide help information with a moving picture format for easier understanding by a user, and a method to offer the help information therein.

The present an image forming apparatus in which a user is capable of easily searching help information without a separate host apparatus, and a method to offer the help information therein.

The present general inventive concept also provides an image forming apparatus to provide information suitable for a user's demand as well as help information produced by a manufacturing company, and a method to offer the help information therein.

Additional aspects of the present general inventive concept will be set forth in part in the description which follows and, in part, will be obvious from the description, or may be learned by practice of the present general inventive concept.

The foregoing and/or other aspects and utilities of the present general inventive concept can be achieved by providing a method to offer help information in an image forming apparatus including receiving a search request command to search the help information from a user, searching at least one help moving picture based on the search request command, and displaying a help moving picture corresponding to the search request command.

The method may further include receiving a first help moving picture from a help moving picture generating apparatus and storing the first help moving picture.

The first help moving picture may be stored in the image forming apparatus or a host apparatus.

The first help moving picture may be generated in the help moving picture generating apparatus by the user.

The method may further include generating and displaying at least one user interface (UI) having a menu item about a categorized classification of the first help moving picture.

The method may further include receiving information from the user to select a category of the first help moving picture based on the categorized classification.

The method may further include uploading the first help moving picture to a server.

The method may further include receiving an instruction from the user whether the first help moving picture is uploaded to the server.

The method may further include transmitting the search request command to a server, and downloading a second help moving picture corresponding to the search request command from the server.

The method may further include receiving a categorized classification list about the second help moving picture from the server, and displaying the received categorized classification list.

The categorized classification list may be displayed on the image forming apparatus or a host apparatus.

The foregoing and/or other aspects and utilities of the present general inventive concept can be also achieved by providing an image forming apparatus including an input unit to receive a search request command to search help information from a user, a storage to store at least one help moving picture, a display to display the help moving picture, and a controller to control the display to display a help moving picture corresponding to the search request command.

The image forming apparatus may further include a communication unit to perform data communication with an external apparatus, and the controller may receive a first help moving picture from a help moving picture generating apparatus through the communication unit and stores the received first help moving picture in the storage.

The first help moving picture may be generated in the help moving picture generating apparatus by the user.

The image forming apparatus may further include a user interface (UI) generator to generate at least one UI having a menu item about a categorized classification of the first help moving picture stored in the storage, and the controller may control the display to display the generated UI.

The controller may control storing the first help moving picture in a category selected by the user based on the categorized classification.

The controller may control the communication unit to upload the first help moving picture stored in the storage to a server.

The controller may upload the first help moving picture to the server by an instruction from the user.

The controller may transmit the search request command to a server through the communication unit and download a second help moving picture corresponding to the search request command from the server.

The controller may receive a categorized classification list about the second help moving picture from the server and display the received categorized classification list on the display.

The foregoing and/or other aspects and utilities of the general inventive concept may also be achieved by providing an image forming system comprising at least one of local storage and remote storage to store help information including a plurality of help moving pictures and corresponding categorized classification lists, an input unit to receive a search request command to search the help information and select a category from a respective categorized classification list corresponding to the search request command, and a user interface (UI) generator to generate a user interface (UI) including the respective categorized classification list.

The foregoing and/or other aspects and utilities of the general inventive concept may also be achieved by providing a method of obtaining help information in an image forming system, the method comprising receiving a search request command to search the help information including a plurality of help moving pictures and corresponding categorized classification lists stored in at least one of local storage and remote storage, generating a user interface (UI) including a respective categorized classification list corresponding to the search request command, and selecting a category from the generated categorized classification list.

The foregoing and/or other aspects and utilities of the general inventive concept may also be achieved by providing a computer-readable recording medium having embodied thereon a computer program to execute a method, wherein the method comprises receiving a search request command to search help information including a plurality of help moving pictures and corresponding categorized classification lists stored in at least one of local storage and remote storage, generating a user interface (UI) including a respective categorized classification list corresponding to the search request command, and selecting a category from the generated categorized classification list.

### BRIEF DESCRIPTION OF THE DRAWINGS

The above and/or other aspects of the present general inventive concept will become apparent and more readily appreciated from the following description of the exemplary embodiments, taken in conjunction with the accompanying drawings, in which:

FIGS. 1 and 2 are block diagrams illustrating a configuration of an image forming apparatus according to exemplary embodiments of the present general inventive concept;

FIG. 3 illustrates a communication relationship of help moving picture data by the image forming apparatus according to the exemplary embodiment of FIG. 2;

FIG. 4 illustrates an example of a categorized classification of storage according to an embodiment of the present general inventive concept; and

FIGS. 5 to 7 are flowcharts illustrating a method to offer help information of an image forming apparatus according to embodiments of the present general inventive concept.

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to like elements throughout. The embodiments are described below so as to explain the present general inventive concept by referring to the figures.

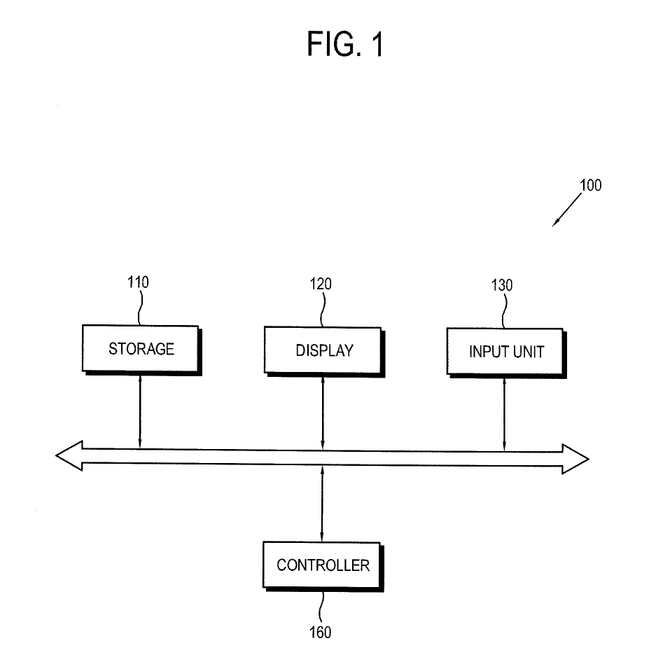

An image forming apparatus 100 according to exemplary embodiments of the present general inventive concept will be described by referring to FIGS. 1 to 3. Here, the image forming apparatus 100 may include a multi function apparatus, a printer, a fax, a scanner and so on.

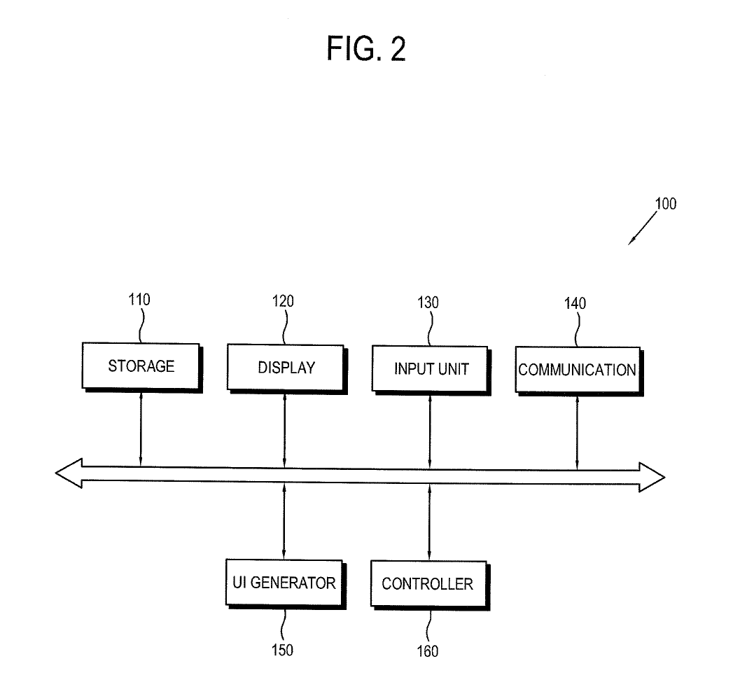

As illustrated in FIGS. 1 and 2, the image forming apparatus 100 includes a storage 110, a display 120, an input unit 130, a communication unit 140, a user interface (UI) generator 150 and a controller 160.

The image forming apparatus 100 performs various operations according to various operation modes. For instance, the multi function apparatus may have various operation modes such as a text mode, a black and white mode, a color mode according to a magnification of a copy or printing, a density of image data or an output object, a type of a sheet, an interruption operation, a feeding method, and a data processing method.

A user needs to know how to use the image forming apparatus based on the respective operation modes and solve a problem such as a paper jam.

The storage 110 stores at least one help moving picture.

Here, the help moving picture is about a using method or a problem solving method of the image forming apparatus 100, and may be filmed with a moving picture generating apparatus 200 such as a camcorder by a service man or an experienced user to illustrate the method using the image forming apparatus 100 or solving the problem.

The display 120 is capable of displaying the help moving picture and is applied to various types of display modules such as a DLP (Digital Light Processing), an LCD (Liquid Crystal Display), and a PDP (Plasma Display Panel).

The input unit 130 may be provided as an operation panel at a side of the image forming apparatus 100 to receive an instruction from the user.

A help moving picture captured by the moving picture generating apparatus 200 (hereinafter, called a first help moving picture) is input through the communication unit 140 and is stored in the storage 110 of the image forming apparatus 100.

Herein, the communication unit 140 includes a communication port to connect with the moving picture generating apparatus 200, and the communication port may be_provided as a 1394 port.

The storage 110 may store the help moving picture based on a predetermined categorized classification.

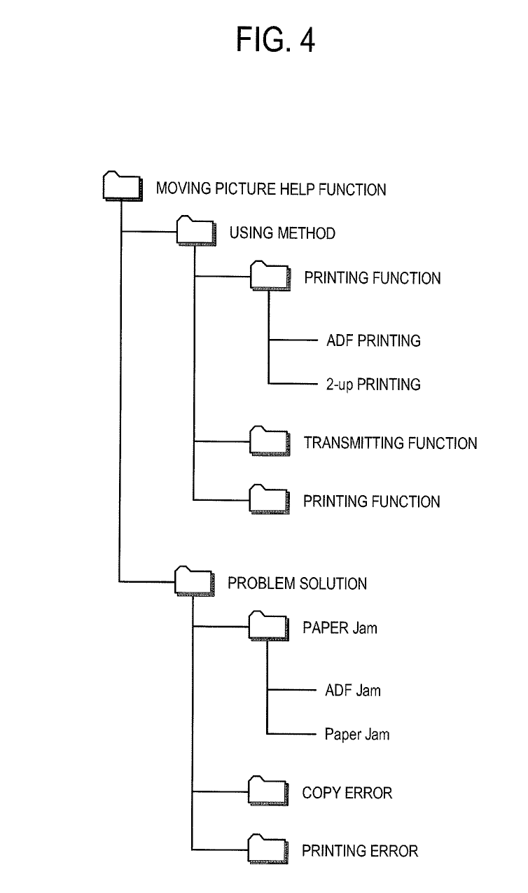

As illustrated in FIG. 4, the help moving picture may be classified into the using method and the problem solution in the multi function apparatus.

The using method may be classified into a copy function, a transmitting function, a print function and so on, and the problem solution may be classified into a paper jam, a copy error, a printing error and so on. Also, the print function can be classified into an Auto Document Feeder (ADF), a 2-up, etc.

The categorized classification of the help moving picture can be classified based on operation modes of the image forming apparatus 100.

The controller 160 generally controls entire operations of the image forming apparatus 100.

Specifically, the controller 160 controls storing the first help moving picture input from the help moving picture generating apparatus 200 in the storage 110 based on the categorized classification.

The UI generator 150 generates at least one User Interface (UI) having a menu item about the categorized classification of the storage 110.

The generated UI is displayed on the display 120 to the user, and the user is capable of storing the categorized first help moving picture in a category the user wants through the displayed UI.

The user selects the category of the first help moving picture based on the categorized classification of the storage 110 through the input unit 130, and the controller 160 stores the first help moving picture in the respective category.

Herein, the stored help moving picture can have a name which is input by the user through the input unit 130 or includes a combination from the respective category to be recognizable by the user.

Specifically, the controller 160 controls the UI generator 150 to generate the UI having the menu item through which the user is capable of inputting or selecting a file name of the first help moving picture, and controls the display 120 to display the generated UI.

If the user inputs the file name of the first help moving picture through the displayed UI, the controller 160 controls to store the input file name in the storage 110 so that the first help moving picture has the input file name.

For example, if the first help moving picture is about the using method of “2-up printing with an automatic sheet feeder”, the file name can be “Help_Function_ADF_{—}2up.xxx” and so on.

The stored file name of the first help moving picture can be revised by the user.

The controller 160 is capable of uploading the first help moving picture stored by the user to a server 400 through the communication unit 140.

The server 400 may be provided as a web server which is capable of storing data provided by a manufacturing company of the image forming apparatus 100, and stores the categorized help moving pictures in the corresponding category which can be provided to the user.

The communication unit 140 may include a wire/wireless communication module to communicate data with an external apparatus.

Specifically, the controller 160 may receive information through the input unit 120 by the user to determine whether to share the first help moving picture in the storage 110 with other users. The controller 160 uploads the first help moving picture to the server 400 based on the information.

The first help moving picture uploaded to the server 400 can be shared among the users using the corresponding image forming apparatus 100 to be downloaded anytime when needed.

The controller 160 may receive a search request command to search the help information by the user through the input unit 120.

Then, the UI generator 150 generates the UI to receive the command by the user, and the controller 160 controls the display 120 to display the generated UI.

The controller 160 determines whether there is a help moving picture corresponding to the search request command among at least one help moving picture in the storage 110.

The controller 160 controls the display 120 to display the help moving picture corresponding to the search request command based on the determination result.

If there is no help moving picture corresponding to the search request command in the storage 110, the controller 160 controls the communication unit 140 to transmit the search request command to the server 400.

Next, the controller 160 controls the communication unit 140 to download a help moving picture corresponding to the search request command from the server 400 (hereinafter, called a second help moving picture).

Herein, the controller 160 receives a categorized classification list for the second help moving picture through the communication unit 140, and may control the display 120 to display the received categorized classification list.

Thus, the user is capable of selecting the second help moving picture that the user wants to display in the categorized classification list of the second help moving picture, and the controller 160 controls the display 120 to display the corresponding second help moving picture based on the selection result.

As described above, the image forming apparatus 100 according to the exemplary embodiments of the present general inventive concept provides the help information having a moving picture format to make the user easily understand the help information and provides the various help moving pictures suitable for the user's demand.

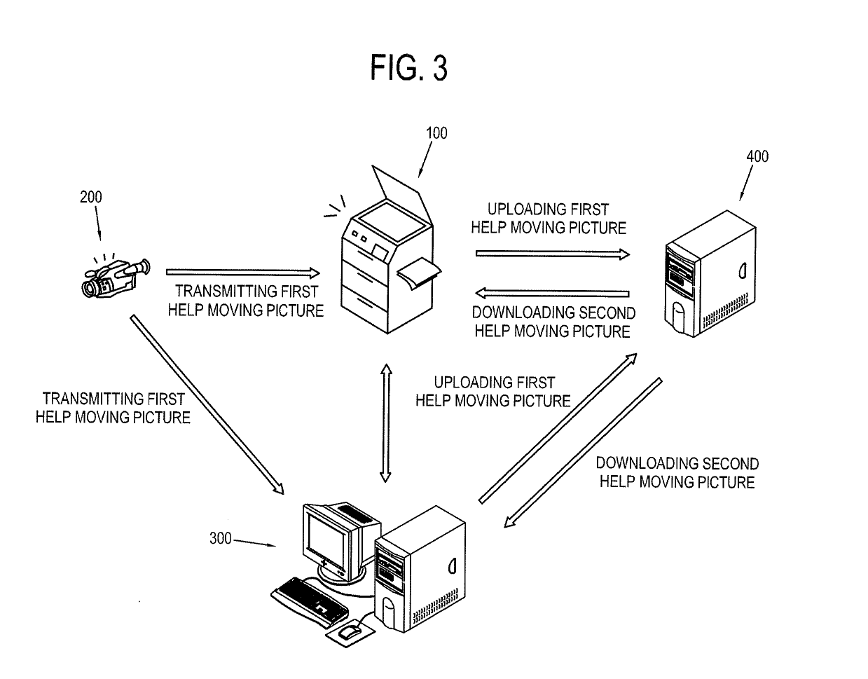

According to another embodiment of the present general inventive concept, the first help moving picture generated in the moving picture generating apparatus 200 may be stored in a host apparatus 300 (see FIG. 3) controlling the operation of the image forming apparatus 200 by the user.

The host apparatus 300 transmits printing data and so on to the image forming apparatus 100 and may include a personal computer and so on. The first help moving picture stored in the host apparatus 300 may be uploaded to the server 400 to be shared.

Also, the second help moving picture downloaded from the server 400 may be stored in and displayed on the host apparatus 300.

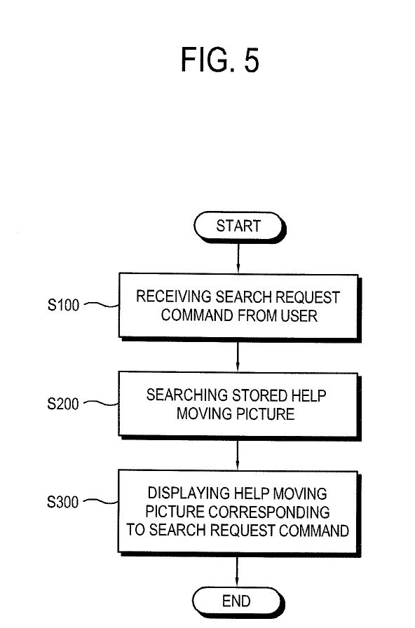

Hereinafter, a control process of the image forming apparatus 100 having the above configuration will be described by referring to FIGS. 5 to 7.

Referring to FIGS. 2, 3, 5 and 6, the controller 160 receives the search request command about the help information from the user through the input unit 130 at operation Si 00.

Next, the controller 160 searches at least one help moving picture stored in the storage 110 or the host apparatus 300 in response to the search request command so as to determine whether there is the help moving picture corresponding to the search request command at operation S200.

Based on the determination result of the operation S200, the controller 160 makes the display 120 or the host apparatus 300 display the help moving picture corresponding to the search request command at operation S300.

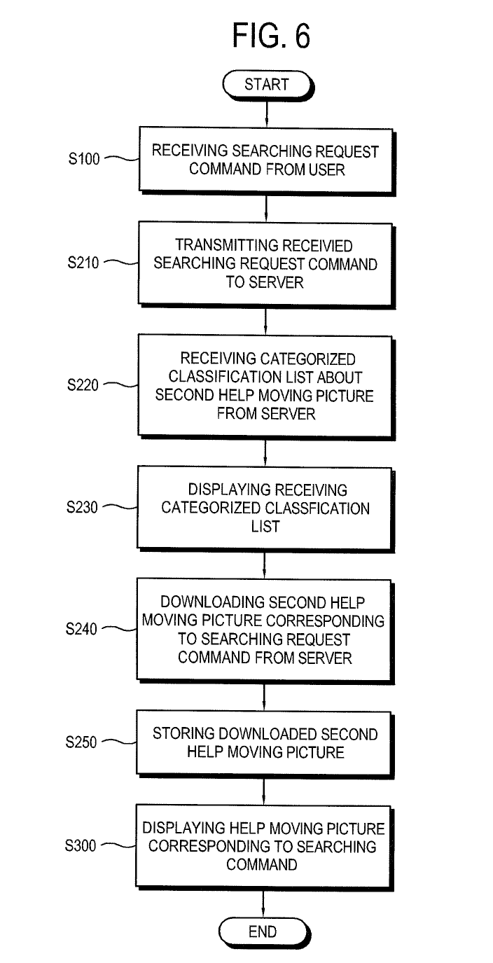

If a determination is made that there is no help moving picture corresponding to the search request command at the operation S200, as illustrated in FIG. 6, the controller 160 may transmit the search request command to the server 400 through the communication unit 140 at operation S210.

Then, the controller 160 receives the categorized classification list about the second help moving picture corresponding to the search request command from the server 400 at operation S220.

The categorized classification list received at the operation S220 is displayed on the display 120 or the host apparatus 300 at operation S230.

Next, the controller 160 downloads the second help moving picture corresponding to the search request command from the server 400 through the communication unit 140 at operation S240.

The second help moving picture downloaded at the operation S240 is stored in the storage 110 or the host apparatus 300 at operation S250.

Next, the controller 160 controls the display 120 or the host apparatus 300 to display the second help moving picture corresponding to the stored search request command at operation S300.

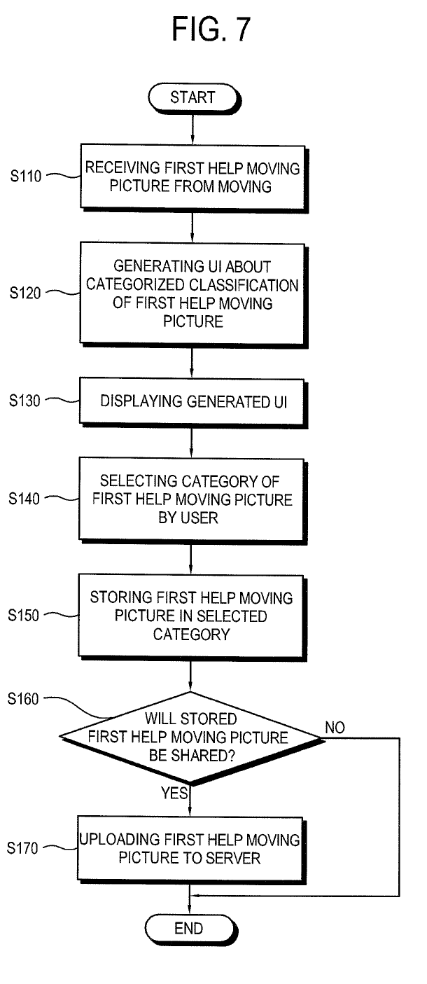

Referring to FIGS. 2 and 7, the controller 160 may receive the first help moving picture generated in the help moving picture generating apparatus 200 (FIG. 3) such as a camcorder before the operation S100 at operation S110.

Here, the controller 160 may control the UI generator 150 to generate at least one UI including the menu item about the categorized classification of the first help moving picture at operation S120.

The UI generated at the operation S120 is displayed on the display 120 at operation S130.

Next, the controller 160 receives information about the category of the first help moving picture selected by the user in the categorized classification through the input unit 130 at operation S140.

The controller 160 controls to store the first help moving picture in the category selected at the operation S140 at operation S150.

Here, the first help moving picture may be stored in the storage 110 or the host apparatus 300.

Next, the controller 160 may receive an instruction from the user whether the user shares the stored first help moving picture with other users at operation S160.

If the user selects to share the first help moving picture at the operation S160, the controller 160 controls the communication unit 140 to upload the first help moving picture to the server 400 at operation S170.

The present general inventive concept can also be embodied as computer-readable codes on a computer-readable medium. The computer-readable medium can include a computer-readable recording medium and a computer-readable transmission medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As described above, the image forming apparatus and the method to offer the help information therein according to various embodiments of the present general inventive concept can provide the help information having a moving picture format for easier understanding of a user.

Furthermore, the user is capable of easily searching the help information without a separate host apparatus.

In addition, different information can be provided according to user's demand in addition to help information produced by a manufacturing company.

Although various exemplary embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. A method to offer help information in an image forming apparatus, the method comprising:
receiving a search request command to search the help information from a user;
searching at least one help moving picture based on the search request command; and
displaying a help moving picture corresponding to the search request command.

2. The method according to claim 1, further comprising:
receiving a first help moving picture from a help moving picture generating apparatus; and
storing the first help moving picture.

3. The method according to claim 2, wherein the first help moving picture is stored in the image forming apparatus or a host apparatus.

4. The method according to claim 2, wherein the first help moving picture is generated in the help moving picture generating apparatus by the user.

5. The method according to claim 2, further comprising:
generating and displaying at least one user interface (UI) having a menu item about a categorized classification of the first help moving picture.

6. The method according to claim 5, further comprising:
receiving information from the user to select a category of the first help moving picture based on the categorized classification.

7. The method according to claim 2, further comprising:
uploading the first help moving picture to a server.

8. The method according to claim 7, further comprising:
receiving an instruction from the user whether the first help moving picture is uploaded to the server.

9. The method according to claim 1, further comprising:
transmitting the search request command to a server; and
downloading a second help moving picture corresponding to the search request command from the server.

10. The method according to claim 9, further comprising:
receiving a categorized classification list about the second help moving picture from the server; and
displaying the received categorized classification list.

11. The method according to claim 10, wherein the categorized classification list is displayed on the image forming apparatus or a host apparatus.

12. An image forming apparatus, comprising:
an input unit to receive a search request command to search help information from a user;
a storage to store at least one help moving picture;
a display to display the help moving picture; and
a controller to control the display to display a help moving picture corresponding to the search request command.

13. The image forming apparatus according to claim 12, further comprising:
a communication unit to perform data communication with an external apparatus,
wherein the controller receives a first help moving picture from a help moving picture generating apparatus through the communication unit and stores the received first help moving picture in the storage.

14. The image forming apparatus according to claim 13, wherein the first help moving picture is generated in the help moving picture generating apparatus by the user.

15. The image forming apparatus according to claim 13, further comprising:
a user interface (UI) generator to generate at least one UI having a menu item about a categorized classification of the first help moving picture stored in the storage,
wherein the controller controls the display to display the generated UI.

16. The image forming apparatus according to claim 15, wherein the controller controls storing the first help moving picture in a category selected by the user based on the categorized classification.

17. The image forming apparatus according to claim 13, wherein the controller controls the communication unit to upload the first help moving picture stored in the storage to a server.

18. The image forming apparatus according to claim 17, wherein the controller uploads the first help moving picture to the server by an instruction from the user.

19. The image forming apparatus according to claim 12, wherein the controller transmits the search request command to a server through the communication unit and downloads a second help moving picture corresponding to the search request command from the server.

20. The image forming apparatus according to claim 19, wherein the controller receives a categorized classification list about the second help moving picture from the server and displays the received categorized classification list on the display.

21. An image forming system, comprising:
at least one of local storage and remote storage to store help information including a plurality of help moving pictures and corresponding categorized classification lists;
an input unit to receive a search request command to search the help information and select a category from a respective categorized classification list corresponding to the search request command; and
a user interface (UI) generator to generate a user interface (UI) including the respective categorized classification list.

22. A method of obtaining help information in an image forming system, the method comprising:
receiving a search request command to search the help information including a plurality of help moving pictures and corresponding categorized classification lists stored in at least one of local storage and remote storage;
generating a user interface (UI) including a respective categorized classification list corresponding to the search request command; and
selecting a category from the generated categorized classification list.

23. A computer-readable recording medium having embodied thereon a computer program to execute a method, wherein the method comprises:
receiving a search request command to search help information including a plurality of help moving pictures and corresponding categorized classification lists stored in at least one of local storage and remote storage;
generating a user interface (UI) including a respective categorized classification list corresponding to the search request command; and
selecting a category from the generated categorized classification list.
